(19) United States
(12) Patent Application Publication
(10) Pub. No.: US 2020/0303690 A1
(43) Pub. Date: Sep. 24, 2020

(54) LABEL FOR BATTERY AND METHOD OF MANUFACTURING LABEL FOR BATTERY

(71) Applicant: FDK CORPORATION, Tokyo (JP)

(72) Inventor: Munekazu Nito, Tokyo (JP)

(73) Assignee: FDK CORPORATION, Tokyo (JP)

(21) Appl. No.: 16/946,167

(22) Filed: Jun. 8, 2020

Related U.S. Application Data
(63) Continuation of application No. PCT/JP2018/032702, filed on Sep. 4, 2018.

(30) Foreign Application Priority Data
Dec. 27, 2017 (JP) 2017-251108

(51) Int. Cl. H01M 2/02; G09F 3/02

(52) U.S. Cl. CPC H01M 2/0267; G09F 2003/0276; G09F 3/02; H01M 2/026

(57) ABSTRACT

A label for a battery includes a base material sheet; and a phosphorescent print layer famed by applying a phosphorescent material onto a surface of the base material so as to display information concerning the battery. The phosphorescent material is provided in a region on the surface of the base material where the information for identifying the battery is displayed. The information for identifying the battery is information indicating a standard of the battery, for example. The information concerning identification of the battery is information indicating a polarity of the battery.

### CROSS-REFERENCE TO RELATED APPLICATION

This application is a continuation application of International Patent Application No. PCT/JP2018/032702 filed Sep. 4, 2018, which claims the benefit of priority to Japanese Patent Application No. 2017-251108 filed Dec. 27, 2017 in the Japan Patent Office. The entire contents of the International Patent Application are incorporated herein by reference.

### BACKGROUND

### Technical Field

The present disclosure relates to a label for a battery and a method of manufacturing a label for a battery.

### Related Art

Various raw materials and substances can be introduced to exterior labels for batteries, packages for the batteries, labels attached to the packages, and the like depending on the intended use thereof. For example, Japanese Patent Application Publication No. 2004-247141 discloses a method of manufacturing a battery equipped with an exterior label, the method including forming a fluorescent portion at part of an exterior label by applying a fluorescent agent to the part, and inspecting whether or not the exterior label is located at a desired position of the battery by detecting the fluorescent portion. Meanwhile, Japanese Patent Application Publication No. 2004-335229 discloses a battery identifier in order to eliminate production of counterfeit battery packs and batteries, the battery identifier being provided on an outer surface of a battery outer package or an outer surface of a battery case of a battery pack, and including a light-emitting material that emits visible light upon irradiation with invisible light.

In many cases, consumers who obtain such batteries by purchasing and the like store the batteries for future use rather than using the batteries immediately. Nonetheless, such use in future may often take place under a circumstance of a site with insufficient brightness such as at night-time or in the case of an emergency (like a blackout). In this case, it will take a lot of time to find the storage site of the batteries or to take a battery out of the storage site. Moreover, even when the battery is successfully taken out, it may still be difficult to visually check the polarities of the battery and put the battery in a target device quickly due to darkness at the site. If the battery is put in the device incorrectly, it may lead to a breakdown of the device.

As described above, it is often difficult to quickly find a battery intended for use and correctly use the battery under the circumstance such as a dark place where a visual check is difficult.

This disclosure provides a label for a battery and a method of manufacturing a label for a battery, which facilitates a visual check even in a dark place.

### SUMMARY

An aspect of this disclosure is a label for a battery comprising: a base material sheet; and a phosphorescent print layer formed by applying a phosphorescent material onto a surface of the base material so as to display information concerning the battery.

According to this disclosure, it is possible to provide a label for a battery and a method of manufacturing a label for a battery, which facilitates a visual check even in a dark place. Other effects of this disclosure will be clarified in the following description.

### BRIEF DESCRIPTION OF THE DRAWINGS

FIG. 1A is an external diagram of a battery 50 according to an embodiment.

FIG. 1B is a development diagram illustrating an external label 100 for a battery explained as an example of a label for a battery of this embodiment.

FIG. 2 is a cross-sectional structural diagram of the external label 100.

FIG. 3 is a flowchart explaining a process of manufacturing the external label 100 and a process of attachment to the battery 50.

FIG. 4 is an external diagram of the battery 50 with the external label 100 wound and attached.

FIG. 5A is a diagram illustrating an example of a battery container 60 capable of containing at least one battery 50.

FIG. 5B is a diagram illustrating an example of a label 200 for a battery container explained as another example of the label for a battery of an embodiment.

FIG. 5C is a diagram illustrating another example of the label 200 for a battery container explained as another example of the label for a battery of an embodiment.

FIG. 6A is a diagram illustrating an example of a container 70 for containing at least one battery 50.

FIG. 6B is a diagram illustrating an example of an enclosure label 300 for a container for the batteries 50 explained as an example of a label for a battery of an embodiment of this disclosure.

FIG. 7A is an example of a perspective view of a container 400 for the batteries 50 explained as a label for a battery according to an embodiment of this disclosure.

FIG. 7B is an example of a development diagram of the container 400 for the batteries 50 explained as the label for a battery according to the embodiment of this disclosure.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Referring now to the drawings, wherein like reference numerals designate identical or corresponding parts throughout the several views thereof, a label for a battery and a method of manufacturing a label for a battery according to embodiments of the present disclosure are described. As used herein, the singular forms “a”, “an”, and “the” are intended to include the plural forms as well, unless the context clearly indicates otherwise. Embodiments of this disclosure will be described below in reference to the drawings.

### <External Label>

### (Overall Configuration)

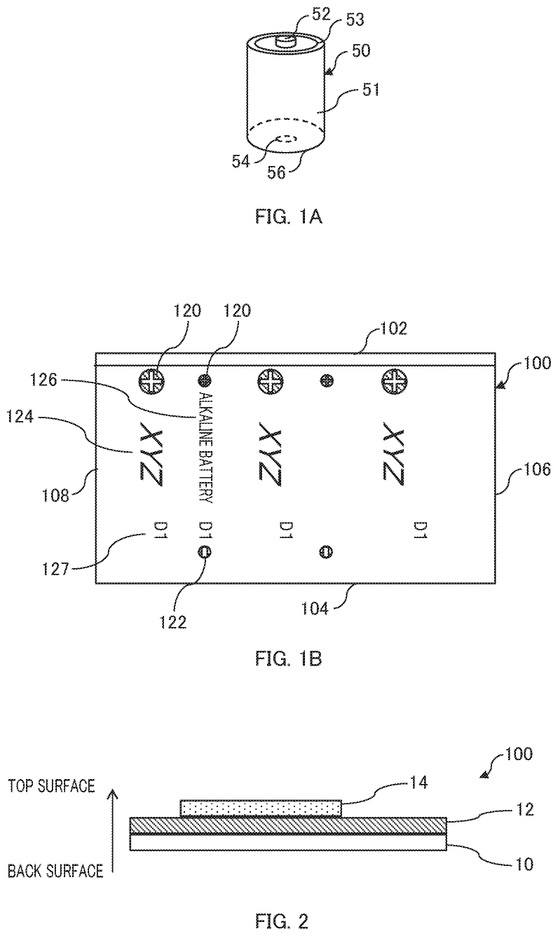

FIG. 1A is an external diagram of a battery 50 illustrated as an example. FIG. 1B is a development diagram illustrating an external label 100 for the battery 50 explained as an example of a label for a battery according to this embodiment. This external label 100 is a label in the form of a substantially rectangular sheet to be wound and fixed to a side surface 51 of a trunk of a cylindrical battery 50 (a D alkaline dry battery in FIG. 1A). One long side 102 of the external label 100 corresponds to an outer periphery 53 of an end surface on a positive electrode 52 side of the battery 50, while the other long side 104 corresponds to an outer periphery 56 of an end surface on a negative electrode 54 side of the battery 50.

A surface of the external label 100 is provided with a region in which characters, figures, and the like for identifying the battery 50 are provided by phosphorescent printing with a pigment containing a given phosphorescent material (hereinafter referred to as a phosphorescent print region). Specifically, characters or FIG. 124 (such as characters or figures representing a trademark or a manufacturer) for identifying the battery 50, characters 126 indicating a type of the battery 50 (which reads “alkaline battery” in FIG. 1B), and characters 127 indicating a standard of the battery (which reads “D” representing a standard concerning the size of the battery 50 in FIG. 1B) are provided by phosphorescent printing at a central part of the external label 100.

Meanwhile, Figures 120 indicating the positive electrode are provided by phosphorescent printing in the vicinity of the one long side 102 of the external label 100. Likewise, figures 122 indicating the negative electrode are provided by phosphorescent printing in the vicinity of the other long side 104.

### (Cross-Sectional Structure)

Next, a structure of the external label 100 will be described. FIG. 2 is a cross-sectional structural diagram of the external label 100. The external label 100 includes an adhesive layer 10, a base layer 12, and a phosphorescent print layer 14 that are arranged in this order from a back surface to a top surface of the external label. Among them, the base layer 12 includes a heat-shrinkable film as a base material of the external label 100, which is a film having a heat-shrinkable property made of a polyester-based resin, an olefin-based resin, a styrene-based resin, a vinyl chloride-based resin, or the like. Meanwhile, the adhesive layer 10 contains a heat-sensitive adhesive for establishing adhesion to the side surface 51 of the battery 50.

The phosphorescent print layer 14 is a layer that includes a phosphorescent paint. This phosphorescent paint is a paint that contains a phosphorescent material and a solvent such as an organic solvent. Of these components, the phosphorescent material is not limited to a particular substance as long as the material is made of a substance that can absorb and accumulate light such as visible light (or ultraviolet light) as energy and autonomously emit this energy as visible light. Examples of the phosphorescent material include strontium aluminate-based phosphorescent pigments that contain strontium and aluminum as chief components, phosphorescent pigments that contain strontium, magnesium, and silicon as chief components, and sulfide-based phosphorescent pigments. Examples of the strontium aluminate-based phosphorescent pigments include Sr₄Al₄O₂₅, SrAl₂O₄, and the like. Examples of the pigments containing strontium, magnesium, and silicon as chief components include Sr₂MgSi₂O₇ and the like.

### (Manufacturing of External Label 100 and Attachment to Battery 50)

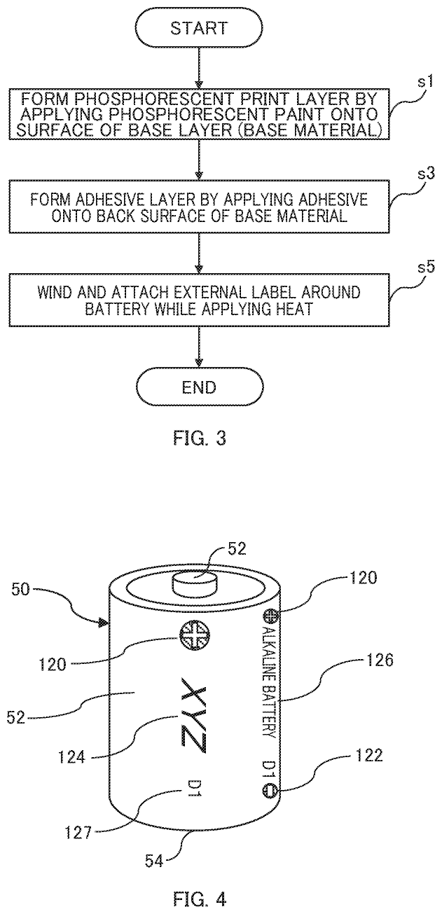

Next, a description will be given of a process of manufacturing the external label 100 and a process of attaching the external label 100 to the battery 50. FIG. 3 is a flowchart explaining the process of manufacturing the external label 100 and the process of attachment to the battery 50. First, the base layer 12 (the base material) is prepared and the phosphorescent print layer 14 is famed by printing or applying the phosphorescent paint to a predetermined region (that is, the phosphorescent print region) on the surface of the base layer 12 (s1). Meanwhile, the adhesive layer 10 is formed by applying the heat-sensitive adhesive onto the entire back surface of the base layer 12 (s3). Thus, the external label 100 is formed.

Here, it is possible to adjust the type, an amount, a thickness, and the like of a raw material of the phosphorescent paint (the phosphorescent material) in s1 in such a way that the battery 50 can continue the autonomous light emission for a time (such as several minutes) required by a user of the battery 50 to find a storage site of the battery 50 and to take out the battery 50 in a dark place (such as at night-time or in a blackout), for example. Meanwhile, any of publicly known printing methods including relief printing, intaglio printing, planographic printing, screen printing, and the like can be used as a mode of the phosphorescent printing in s1.

Next, the external label 100 thus famed is wound around the side surface 51 of the trunk of the battery 50 and is attached to the battery 50 by heating (s5). To be more precise, the one long side 102 of the external label 100 is aligned with the outer periphery 53 of the end surface on the positive electrode 52 side of the battery 50 and the other long side 104 of the external label 100 is aligned with the outer periphery 56 of the end surface on the negative electrode 54 side of the battery 50. In this state, one short side 106 of the external label 100 is arranged substantially parallel to an axial direction of the battery 50 and is attached to the side surface 51 of the battery 50. Then, the external label 100 is wound around the side surface 51 and a portion of the adhesive layer 10 on the other short side 108 of the external label 100 is attached to a surface of the one short side 106. The external label 100 in this state is shrunk by heating, so that the external label 100 can be wound around and attached to the side surface 51 of the battery 50.

FIG. 4 is an external diagram of the battery 50 with the external label 100 wound and attached. As illustrated in FIG. 4, the figures 120 indicating the positive electrode are displayed in the vicinity of the positive electrode 52 of the battery 50 while the figures 122 indicating the negative electrode are displayed in the vicinity of the negative electrode 54 of the battery 50. Moreover, the characters or figures 124 (such as the name of the battery 50 and the name of a manufacturer) for identifying the battery 50, the characters 126 indicating the type of the battery 50, and the characters 127 indicating the standard of the battery 50 are displayed at the central part of the side surface 51 of the battery 50.

As described above, the label for a battery (the external label 100) of this embodiment is provided with the phosphorescent material on the surface of the label by phosphorescent printing. Accordingly, this phosphorescent material emits the light based on the energy accumulated therein under a use condition of the battery 50 in the dark such as at night-time or in a blackout. Then, this phosphorescent material is provided in the region (the phosphorescent print region) on the surface of the label where the information for identifying the battery 50 is displayed, so that a user of the battery 50 can certainly identify and visually check the battery 50 to use even under a use condition which is a dark place. Thus, the user can quickly find and use the desired battery 50.

For example, the information for identifying the battery 50 is the information indicating the standard of the battery 50 (the characters 127 indicating the standard of the battery 50), so that the user can quickly find the battery 50 of an appropriate standard compatible with a device intended for use. Meanwhile, the information for identifying the battery 50 is the information (the figures 120 indicating the positive electrode and the figures 122 indicating the negative electrode) which indicates the polarities (the positive electrode 52 and the negative electrode 54) of the battery 50. Accordingly, the user can correctly recognize the respective positions of the polarities (the positive electrode 52 and the negative electrode 54) of the battery 50 and correctly and safely put the battery 50 in the device intended for use. Moreover, since the label (the external label 100) is a sheet member to be wound around and attached to the surface of a battery 50, the label enables easy finding of each battery 50 intended for use.

### <Label for Container>

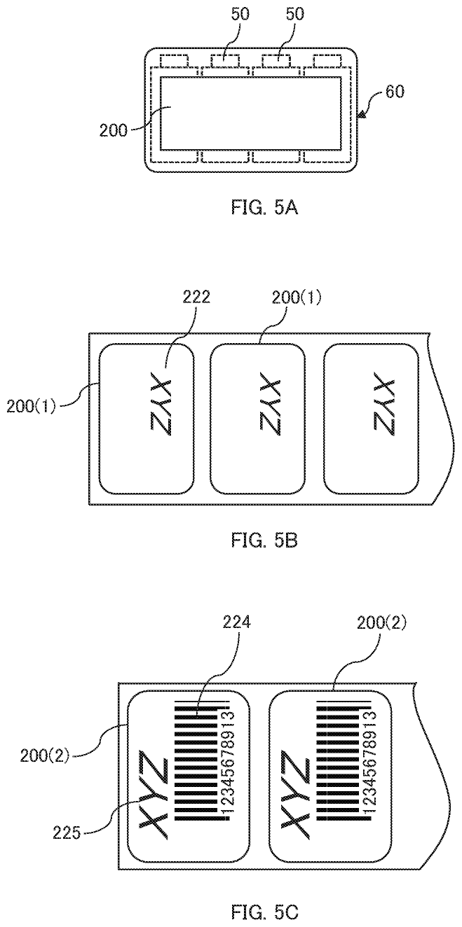

FIG. 5A illustrates a battery container 60 (such as a resin sheet) capable of containing at least one battery 50. FIGS. 5B and 5C are diagrams each illustrating an example of a label 200 for a battery container explained as an example of the label for a battery of this embodiment. As illustrated in FIGS. 5B and 5C, the label 200 for a container is a paper label, for example, which is to be attached to a side surface of the battery container 60. As illustrated in FIGS. 5B and 5C, for example, the label 200 for a container is any of a label 200(1) for identifying the battery 50, a label 200(2) provided with a bar code corresponding to the battery 50, and the like.

First, as with the external label 100, a surface of the label 200(1) is provided with a phosphorescent print region in which characters, a figure, or the like are provided by phosphorescent printing with an ink (a phosphorescent ink) containing a given phosphorescent material. Specifically, characters or FIG. 222 (such as characters or figure representing a trademark or a manufacturer) for identifying the battery 50 contained in the container 60 are provided by phosphorescent printing at a central part of the label 200(1) with the phosphorescent material similar to that used in the external label 100.

On the other hand, the bar-coded label 200(2) is a label displaying a bar code 224 corresponding to the battery 50 for sale contained therein, and characters or FIG. 225 (such as characters or figure representing a trademark or a manufacturer) for identifying the battery 50 are provided in the vicinity of this bar code 224 by phosphorescent printing with the phosphorescent material similar to that used in the external label 100.

As described above, in the label 200 for a container, the phosphorescent material is provided in the region (the phosphorescent print region) on the surface of the label where the information for identifying the battery 50 is displayed, so that a user of the battery 50 can certainly identify and visually check the battery 50 to use even under a use condition in the dark. Moreover, the label 200 for a container is the label to be provided to the container 60 for containing at least one battery 50, so that the user can quickly find the container 60 that contains the desired battery 50 and use the battery 50 in the container 60.

Note that a process of manufacturing this label 200 for a container is similar to s1 and s3 in the case of the external label 100 except that the base layer 12 is made of a paper material and the adhesive layer 10 contains an adhesive that can establish adhesion to the surface of the container 60 in each of the examples illustrated in FIGS. 5B and 5C. The base layer 12 of the label 200 may include a material other than the paper material such as a resin, a metal, and a film.

### <Enclosure Label for Container>

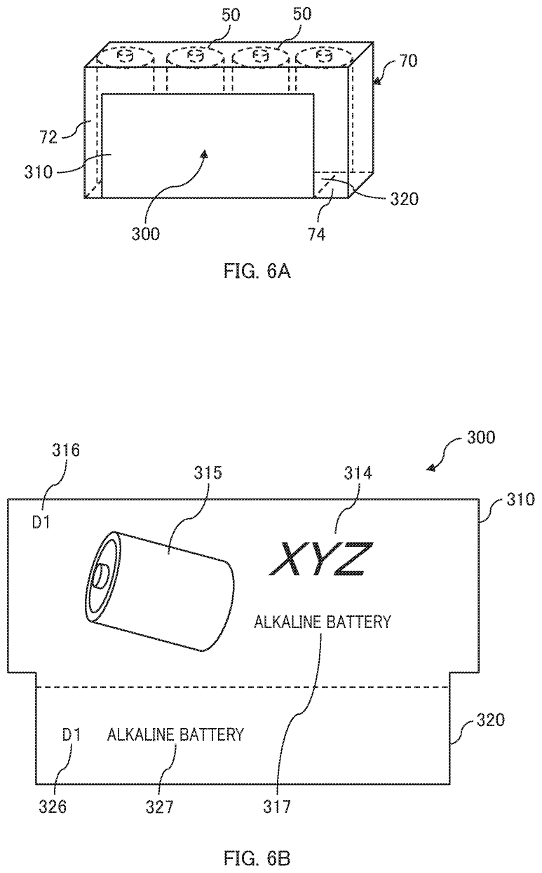

FIG. 6A illustrates a container 70 (such as a transparent container made of a resin) for containing at least one battery 50. FIG. 6B illustrates an example of an enclosure label 300 for a container for the batteries 50 explained as a label for a battery according to an embodiment of this disclosure. This enclosure label 300 for a container is a piece of a cardboard to be enclosed in the container 70 together with the batteries 50.

This enclosure label 300 for a container has a first surface 310 that constitutes part of a side surface 72 of the container 70 and a second surface 320 that constitutes part of a bottom surface 74 of the container 70.

Each of the first surface 310 and the second surface 320 is provided with a phosphorescent print region. First, characters or a FIG. 314 (such as characters or a figure representing a trademark or a manufacturer) for identifying the battery 50, a FIG. 315 imitating an external appearance of the battery 50, a character 316 indicating the standard of the battery 50 (which reads “D” in FIG. 6B), and characters 317 indicating the type of the battery 50 (which reads “alkaline battery” in FIG. 6B) are provided by phosphorescent printing on the first surface 310 with a phosphorescent ink made of a raw material similar to that used in the external label 100. Meanwhile, a character 326 indicating the standard of the battery 50 (which reads “D” in FIG. 6B) and characters 327 indicating the type of the battery 50 (which reads “alkaline battery” in FIG. 6B) are provided by phosphorescent printing on the second surface 320 with the phosphorescent ink.

As described above, in the enclosure label 300, the phosphorescent material is provided in the regions (the phosphorescent print regions) on the surfaces of the label where the information for identifying the battery 50 is displayed, so that a user of the battery 50 can certainly identify and visually check the battery 50 to use even under a use condition in the dark. Moreover, the enclosure label 300 is the label to be enclosed together with the batteries 50 in the container 70 for containing at least one battery 50, so that the user can quickly find the container 70 that contains this label 300 and use the battery 50 in the container 70.

Note that a process of forming the enclosure label 300 is similar to s1 in the case of the external label 100 except that the base layer 12 is made of a paper material in the example of FIG. 6B. The base layer 12 of the enclosure label 300 may include a material other than the paper material such as a resin, a metal, and a film.

### <Container for Batteries>

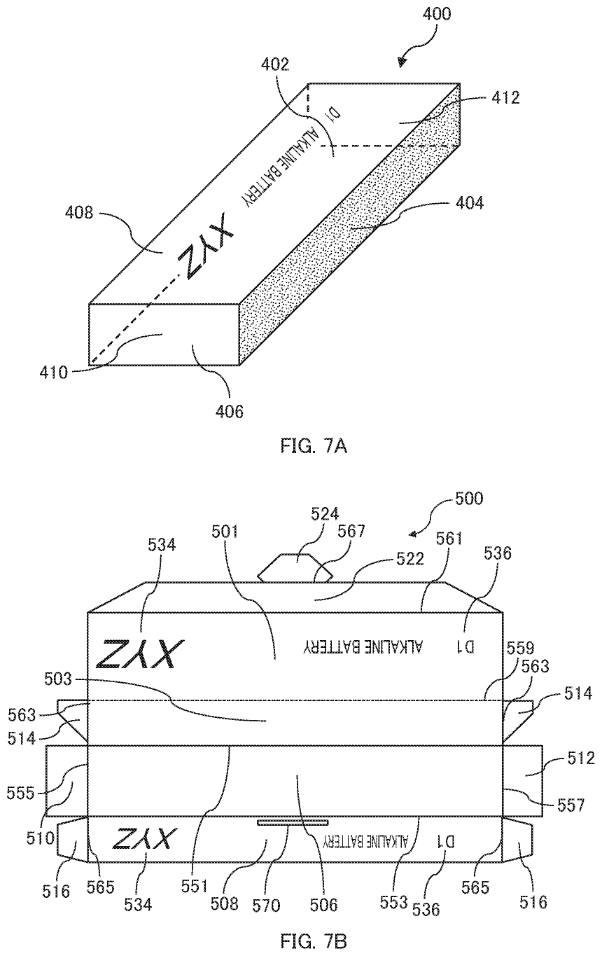

FIG. 7A is a perspective view of a container 400 for the batteries 50 explained as an example of a label for a battery according to an embodiment of this disclosure. FIG. 7B is a development diagram of the container 400. The container 400 is a container formed in a rectangular parallelepiped shape by using a resin, a paper material, or the like as a raw material (a base material). The container 400 can contain at least one battery 50.

A developed sheet 500 of the container 400 illustrated in FIG. 7B has a first surface 501 that constitutes an upper surface 402 of the container 400, a second surface 503 that constitutes a first side surface 404 of the container 400 and is adjacent to the first surface 501 across a mountain fold line 559 as a boundary line, a third surface 506 that constitutes a bottom surface 406 of the container 400 and is adjacent to the second surface 503 across a mountain fold line 551 as a boundary line, a fourth surface 508 that constitutes a second side surface 408 opposed to the first side surface 404 and is adjacent to the third surface 506 across a mountain fold line 553 as a boundary line, a fifth surface 510 that forms a third side surface 410 of the container 400 and is adjacent to the third surface 506 across a mountain fold line 555 as a boundary line, a sixth surface 512 that constitutes a fourth side surface 412 opposed to the third side surface 410 and is adjacent to the third surface 506 across a mountain fold line 557 as a boundary line, and a seventh surface 522 that is provided corresponding to the fourth surface 508 and is adjacent to the first surface 501 across a mountain fold line 561 opposite to the mountain fold line 559 as a boundary line. Moreover, two paste margin surfaces 514 are provided on two ends of the second surface 503 and adjacent to the second surface 503 across mountain fold lines 563 as boundaries, and two paste margin surfaces 516 are also provided on two ends of the fourth surface 508 and adjacent to the fourth surface 508 across mountain fold lines 565 as boundaries. Meanwhile, the fourth surface 508 is provided with a slit 570. On the other hand, the seventh surface 522 is provided with a tab 524 that is adjacent to the seventh surface 522 across a mountain fold line 567 as a boundary line and is to be inserted into the slit 570.

Moreover, the first surface 501 and the fourth surface 508 of the developed sheet 500 are provided with phosphorescent print regions. Specifically, characters or a FIG. 534 (such as characters or a figure representing a trademark or a manufacturer) for identifying the battery 50 contained in the container 400 and characters 536 indicating the type and the standard of the battery 50 (which reads “D alkaline battery” in FIG. 7B) are provided by phosphorescent printing with a phosphorescent material similar to that used in the external label 100. Note that a phosphorescent printing method used for this developed sheet 500 is similar to the method used for the enclosure label 300.

Here, a method of forming the container 400 based on the developed sheet 500 will be described. First, the mountain fold lines 551, 553, 555, 557, 559, 561, 563, and 565 of the developed sheet 500 are each mountain-folded. Then, the paste margin surfaces 514 and the paste margin surfaces 516 are attached to the back surfaces of the fifth surface 510 and the sixth surface 512. Moreover, the tab 524 provided to the seventh surface 522 is inserted into the slit 570 of the fourth surface 508. Thus, the container 400 in the rectangular parallelepiped shape is famed.

In the container 400 formed as described above, the characters or FIG. 534 for identifying the battery 50 and the characters 536 indicating the type and the standard of the battery 50, which are provided by phosphorescent printing, are displayed on the upper surface 402 and the second side surface 408.

Accordingly, in the container 400, the phosphorescent material is provided in the regions (the phosphorescent print regions) on the surfaces of the container 400 where the information for identifying the battery 50 is displayed, so that a user of the battery 50 can certainly identify and visually check the battery 50 to use even under a use condition in the dark. Moreover, the container 400 is formed as the container 400 to contain at least one battery 50, so that the user can quickly find the container 400 that contains the desired battery 50 and use the battery 50 in the container 400.

As described above, according to the labels for a battery (the external label 100, the label 200 for a container, the enclosure label 300, the container 400, and the developed sheet 500) of this embodiment, the phosphorescent material is provided on the surface by phosphorescent printing. As a consequence, this phosphorescent material autonomously emits the light based on the energy accumulated therein under a use condition of the battery 50 in the dark such as at night-time or in a blackout. Then, this phosphorescent material is provided in the region (the phosphorescent print region) on the surface of the label where the information for identifying the battery 50 is displayed, so that a user of the battery 50 can certainly identify and visually check the battery 50 to use even under the use condition which is the dark place. Thus, the user can quickly find and use the desired battery 50.

In sum, an aspect of this disclosure is a label for a battery provided in order to display information concerning a battery, which includes a base material sheet, and a phosphorescent print layer formed by applying a phosphorescent material onto a surface of the base material so as to display the information concerning the battery.

According to this disclosure, since the phosphorescent material is provided on the surface of the label for a battery, this phosphorescent material autonomously emits the light based on the energy accumulated therein under a use condition of a battery in the dark such as at night-time or in a blackout. Thus, a user of the battery can quickly find and use the desired battery.

In an aspect of this disclosure, the phosphorescent material is provided in a region on the surface of the base material where the information for identifying the battery is displayed. Thus, a user of the battery can certainly identify and visually check the battery to use under the use condition.

In an aspect of this disclosure, the information for identifying the battery is information indicating a standard of the battery. Thus, the user can quickly find the battery of an appropriate standard compatible with a device intended for use.

In an aspect of this disclosure, the information concerning identification of the battery is information indicating a polarity of the battery. Thus, the user can correctly recognize the respective positions of the polarities (the positive electrode and the negative electrode) of the battery and correctly and safely put the battery in a device intended for use.

In an aspect of this disclosure, the base material is a sheet member such as a film to be wound around and attached to the surface of the battery. Thus, it is possible to easily find each battery intended for use.

In an aspect of this disclosure, the base material is made of any of a paper material, a resin, a metal, and a film and is provided to a container configured to contain at least the one battery. Thus, the user can quickly find the container that contains a desired battery and use the battery in the container.

In an aspect of this disclosure, the base material is made of any of a paper material, a resin, a metal, and a film and is enclosed together with the battery in a container configured to contain at least the one battery. Thus, the user can quickly find the container enclosing this label and use the battery in the container.

In an aspect of this disclosure, the base material is made of a raw material of a container configured to contain at least the one battery. Thus, the user can quickly find the container that contains the desired battery and use the battery in the container.

Meanwhile, another aspect of this disclosure is a method of manufacturing a label for a battery, the method including preparing a base material and applying a phosphorescent material onto a surface of the base material so as to display information concerning the battery. According to this method, it is possible to manufacture a label for a battery which is capable of autonomously emitting light based on energy accumulated therein under a use condition of the battery in the dark such as at night-time or in a blackout. Thus, a user of the battery can quickly find and use the desired battery.

The above description of the embodiments has been made in order to facilitate the understanding of this disclosure and is not intended to limit the scope of this disclosure. This disclosure can be changed and modified without departing from the gist of the disclosure, and also encompasses such equivalents.

For example, arrangements, directions, positions, standards and the like of the figures and the characters provided by the phosphorescent printing on the external label 100 can be changed as appropriate. Although the battery 50 is assumed to be a cylindrical dry battery in this embodiment, the shape and the type of the battery 50 are not limited to the foregoing. For instance, the battery may be of a different shape or a different type such as a secondary battery or a button battery.

In the case of using the label for a battery according to this embodiment, it is desirable that the user of the battery 50 keep the battery 50 in a bright place for a certain period so as to accumulate the energy in the phosphorescent print region.

What is claimed is:

1. A label for a battery comprising:
a base material sheet; and
a phosphorescent print layer famed by applying a phosphorescent material onto a surface of the base material so as to display information concerning the battery.

2. The label for a battery according to claim 1, wherein the phosphorescent material is provided in a region on the surface of the base material where the information for identifying the battery is displayed.

3. The label for a battery according to claim 2, wherein the information for identifying the battery is one of information indicating a standard of the battery and information indicating a polarity of the battery.

4. The label for a battery according to claim 1, wherein the base material is a film to be wound around and attached to the surface of the battery.

5. The label for a battery according to claim 2, wherein the base material is a film to be wound around and attached to the surface of the battery.

6. The label for a battery according to claim 3, wherein the base material is a film to be wound around and attached to the surface of the battery.

7. The label for a battery according to claim 1, wherein the base material is made of any of a paper material, a resin, a metal, and a film and is provided to a container configured to contain at least the one battery.

8. The label for a battery according to claim 2, wherein the base material is made of any of a paper material, a resin, a metal, and a film and is provided to a container configured to contain at least the one battery.

9. The label for a battery according to claim 3, wherein the base material is made of any of a paper material, a resin, a metal, and a film and is provided to a container configured to contain at least the one battery.

10. The label for a battery according to claim 1, wherein the base material is made of any of a paper material, a resin, a metal, and a film and is enclosed together with the battery in a container configured to contain at least the one battery.

11. The label for a battery according to claim 2, wherein the base material is made of any of a paper material, a resin, a metal, and a film and is enclosed together with the battery in a container configured to contain at least the one battery.

12. The label for a battery according to claim 3, wherein the base material is made of any of a paper material, a resin, a metal, and a film and is enclosed together with the battery in a container configured to contain at least the one battery.

13. The label for a battery according to claim 1, wherein the base material is made of a raw material of a container configured to contain at least the one battery.

14. The label for a battery according to claim 2, wherein the base material is made of a raw material of a container configured to contain at least the one battery.

15. The label for a battery according to claim 3, wherein the base material is made of a raw material of a container configured to contain at least the one battery.

16. A method of manufacturing a label for a battery, comprising:
preparing a base material; and
applying a phosphorescent material onto a surface of the base material so as to display information concerning the battery.
